(19) United States
(12) Patent Application Publication
(10) Pub. No.: US 2024/0375004 A1
(43) Pub. Date: Nov. 14, 2024

(54) METHOD AND APPARATUS FOR PROCESSING INFORMATION IN GAME, ELECTRONIC DEVICE, AND STORAGE MEDIUM

(71) Applicant: NETEASE (HANGZHOU) NETWORK CO., LTD., Hangzhou, Zhejiang (CN)

(72) Inventor: Liu LIU, Hangzhou, Zhejiang (CN)

(73) Assignee: NETEASE (HANGZHOU) NETWORK CO., LTD., Hangzhou, Zhejiang (CN)

(21) Appl. No.: 18/557,313

(22) PCT Filed: Nov. 26, 2021
(86) PCT No.: PCT/CN2021/133519

§ 371 Date: Oct. 26, 2023

(30) Foreign Application Priority Data
May 7, 2021 (CN) 202110514380.0

(51) Int. Cl. A63F 13/56; A63F 13/52

(52) U.S. Cl. CPC A63F 13/56; A63F 13/52

(57) ABSTRACT

Provided is a method and an apparatus for processing information in a game, an electronic device, and a storage medium. The method includes: providing a virtual interactive environment; in response to contact interaction between a first character or a second character and a material in the virtual interactive environment, controlling the material to move in the virtual interactive environment; in response to the material moving into the first mobile carrier or the second mobile carrier, adjusting the position of the first mobile carrier or the second mobile carrier in the virtual interactive environment, and displaying prompt information based on the position of the first mobile carrier or the second mobile carrier; and settling the present game according to a relationship between movement information of the first mobile carrier or the second mobile carrier and a preset settlement condition.

### CROSS REFERENCE TO RELATED APPLICATIONS

The present application is a U.S. national phase application of International Application No. PCT/CN2021/133519, filed on Nov. 26, 2021, which is based upon and claims priority to Chinese Patent Application No. 202110514380.0, filed on May 7, 2021 and entitled “METHOD AND APPARATUS FOR PROCESSING INFORMATION IN GAME, ELECTRONIC DEVICE, AND STORAGE MEDIUM”, the entire contents of both of which are incorporated herein by reference for all purposes.

### TECHNICAL FIELD

The present disclosure relates to the technical field of online games, in particular to a method and an apparatus for processing information in a game, an electronic device, and a storage medium.

### BACKGROUND

In some games, players are divided into two game camps, where virtual characters belonging to different game camps compete with each other, and virtual characters belonging to the same camp cooperate with each other. The main tasks of the game are to jointly challenge and adventure. The game sets an endpoint for each game camp, and players need to control the virtual characters to reach the endpoint. During the competition, there can be obstacles, and other players in the game can also release interference skills. The players play according to the established game content in the game, and the game content has not changed much. The player in the game camp who reaches the endpoint of the game first wins.

It should be noted that the information disclosed in above section above is only used to enhance the understanding of the background of the present disclosure, and thus can include information that does not constitute prior art already known to those of ordinary skill in the art.

### SUMMARY

In a first aspect, the present disclosure provides a method for processing information in a game, which includes: providing, in response to a starting condition of a present game, a virtual interactive environment configured for interaction between a first character belonging to a first camp and a second character belonging to a second camp, wherein the virtual interactive environment has a first mobile carrier corresponding to the first camp and a second mobile carrier corresponding to the second camp; controlling, in response to contact interaction between the first character or the second character and the material, the material to move in the virtual interactive environment; controlling, in response to the material moving into the first mobile carrier or the second mobile carrier, the first mobile carrier or the second mobile carrier to adjust a position of the first mobile carrier or the second mobile carrier in the virtual interactive environment, and displaying, based on the position of the first mobile carrier or the second mobile carrier in the virtual interactive environment, prompt information on a graphical user interface of a terminal device, wherein the prompt information is configured to represent movement information of the first mobile carrier or the second mobile carrier; and settling, in response to the movement information of the first mobile carrier or the second mobile carrier meeting a preset settlement condition, the present game.

In a second aspect, the present disclosure provides an electronic device including a processor, a memory, and a bus, wherein the memory stores machine readable instructions executable by the processor, and when the electronic device is running, the processor communicates with the memory through the bus, and the processor executes the machine readable instructions to execute steps of the method for processing the information in the game as described above.

In a third aspect, the present disclosure provides a non-transitory computer-readable storage medium having a program stored thereon, which when executed by a processor, causes the method for processing the information in the game as described above.

It should be understood that the general description above and the detailed description in the following are only illustrative and do not limit the present disclosure.

### BRIEF DESCRIPTION OF THE DRAWINGS

In order to provide a clearer explanation of specific embodiments in the present disclosure or technical solutions in the prior art, the drawings required for the specific embodiments or description of the prior art will be briefly introduced in the following. It is apparent that the drawings in the following description are only some embodiments of the present disclosure, and for those of ordinary skill in the art, other drawings can also be obtained from these drawings without creative efforts.

FIG. 1 is a flowchart of a method for processing information in a game according to one or more embodiments of the present disclosure;

FIG. 2 is a design diagram of a level in a multiplayer online competitive game according to one or more embodiments of the present disclosure:

FIG. 3 is a schematic structural diagram of an apparatus for processing information in a game according to one or more embodiments of the present disclosure; and

FIG. 4 is a schematic structural diagram of an electronic device according to one or more embodiments of the present disclosure.

### DETAILED DESCRIPTION

In order to make the purpose, technical solutions, and advantages of embodiments of the present disclosure clearer, a clear and complete description of the technical solution in embodiments of the present disclosure will be provided in the following in conjunction with the drawings. Obviously, the embodiments described are only a part of the embodiments of the present disclosure, not all of them. The components of the embodiments of the present disclosure typically described and shown in the drawings, can be arranged and designed in various different configurations. Therefore, the detailed description of the embodiments of the present disclosure provided in the drawings is not intended to limit the protection scope of the present disclosure, but only to represent the selected embodiments of the present disclosure. Based on the embodiments of the present disclosure, any other embodiment obtained by those skilled in the art without creative efforts falls within the protection scope of the present disclosure.

In some games, players are divided into two game camps, where virtual characters belonging to different game camps compete with each other, and virtual characters belonging to the same camp cooperate with each other. The main tasks of the game are to jointly challenge and adventure. The game sets an endpoint for each game camp, and players need to control the virtual characters to reach the endpoint. During the competition, there can be obstacles, and other players in the game can also release interference skills. The players play according to the established game content in the game, and the game content has not changed much. The player in the game camp who reaches the endpoint of the game first wins.

For example, in a multiplayer online competitive game, multiple players participating in the game enter the same game match. After entering the game match, all virtual characters try to pass the level. There are usually 4 levels in the game. 20 persons are selected from 30 people, then 12 persons are selected, 8 persons are selected, and finally 1 person is selected, who is made to be the winner. In addition, other game levels can also be established. For example, in the multiplayer snowball rolling, which team rolls the snowball larger, which team wins. For example, in the multiplayer football, which team scores the most goals, which team wins.

In some embodiments, the present disclosure improves multiplayer online competitive games by providing a method and an apparatus for processing information in the game, an electronic device, and a storage medium, which can prompt game players about the progress of the game and help the game players with quick locating, so as to improve the locating accuracy of the game.

For the convenience of understanding embodiments of the present disclosure, the method for processing the information in the game according to embodiments of the present disclosure will be first introduced in detail.

Embodiments of the present disclosure provide a method for processing information in the game. The game includes a first camp and a second camp. The first camp includes several first characters, and the second camp includes several second characters.

The game in embodiments of the present disclosure can be a multiplayer online competitive game, and the game in embodiments can be a mobile game, a computer game, or a console game. The game in embodiments can be divided into different game camps, for example, the first camp and the second camp. Virtual characters belonging to different camps can have different identities. For example, the first camp includes several first characters, and the first character belonging to the first camp has a first identity. The second camp includes several second characters, and the second character belonging to the second camp has a second identity.

In some embodiments, virtual characters belonging to the same camp can help each other and complete the tasks of the camp together. Virtual characters belonging to different camps can attack each other to complete their own camp's tasks and prevent the other party from completing their own camp's tasks.

Virtual characters refer to dynamic objects that can be controlled in a virtual interactive environment. In some embodiments, the dynamic object can be a virtual character, a virtual animal, a cartoon character, etc. The virtual object is a character controlled by the player through an input device, or artificial intelligence (AI) established through training in the VERSUS virtual interactive environment, or a non-player character (NPC) established in the VERSUS virtual interactive environment. In some embodiments, the virtual object is a virtual character that competes in the virtual interactive environment. In some embodiments, the number of virtual objects in the VERSUS virtual interactive environment is preset or dynamically determined based on the number of clients participating in the VERSUS, which will be not limited in embodiments of the present disclosure. In some embodiments, the user can control the virtual character to move in the virtual interactive environment. For example, the user can control the virtual character to run, jump, crawl, etc., and can also control the virtual character to use the skills, virtual props, etc. provided by an application, to compete against other virtual characters.

The virtual interactive environment is a virtual scene that is displayed (or provided) when an application runs on a terminal or a server. In some embodiments, the virtual scene is a simulated environment of the real world, or a semi-simulated and semi-fictional virtual environment, or a purely fictional virtual environment. The virtual scene is any of two dimensional virtual scenes and three dimensional virtual scenes. The virtual environment can be sky, land, ocean, etc. The land includes environmental elements such as deserts and cities. In some embodiments, the virtual scene is a scene where the user controls the virtual character to complete the game logic. For example, activities of the virtual character in the virtual interactive environment can include but are not limited to at least one of the following: walking, running, jumping, rolling, lying down, releasing skills, and using props. In some embodiments, active virtual characters in the virtual interactive environment can include not only virtual characters controlled by each player, but also other virtual characters controlled by non-players.

In some embodiments of the present disclosure, a method for processing information in a game is disclosed, which can be applied on a terminal device or a server. In some embodiments, the terminal device can be a local terminal device. When the method for processing the information runs on the server, it can be implemented and performed based on a cloud interactive system, which includes both the server and client devices. When the method for processing the information runs on the terminal device, the game can be a console game.

In some embodiments, various cloud applications, such as cloud games, can run in the cloud interactive system. Taking the cloud games as an example, the cloud game refers to a gaming approach based on cloud computing. In the running mode of cloud games, the running body of the game program and the presenting body of the game picture are separated. The storage and running of the method for the processing information are completed on the cloud game server, and the client device is used to receive and send data, as well as present the game picture. For example, the client device can be a display device with data transmission function near the user side, such as a mobile terminal, a TV, a computer, a handheld computer, etc. The terminal device for perform the information processing is the cloud game server in the cloud. When playing games, players operate the client device to send operation instructions to the cloud game server. The cloud game server runs the game based on the operation instructions, encodes and compresses the game data such as the game picture, and returns the game data to the client device through the network. Finally, the client device decodes and outputs the game picture.

In some embodiments, the terminal device may be a local terminal device. Taking the games as an example, the local terminal device stores the game program for presenting the game picture. The local terminal device is used to interact with players through a graphical user interface, that is, generally, the local terminal device is used to download, install, and run the game program. The local terminal device can provide a graphical user interface to players in various ways, such as rendering and displaying the graphical user interface on the terminal's display screen, or providing the graphical user interface to players through holographic projection. For example, the local terminal device can include a display screen and a processor. The display screen is used to present the graphical user interface that includes the game picture. The processor is used to run the game, generate the graphical user interface, and control the display of the graphical user interface on the display screen.

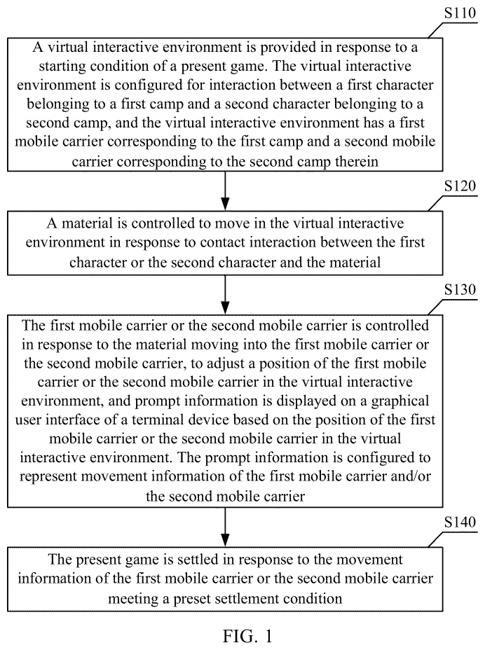

Referring to FIG. 1, a flowchart of a method for processing information in the game according to embodiments of the present disclosure is provided. The method for processing the information in the game includes following steps.

In step S110, a virtual interactive environment is provided in response to a starting condition of a present game. The virtual interactive environment is configured for interaction between a first character belonging to a first camp and a second character belonging to a second camp, and the virtual interactive environment has a first mobile carrier corresponding to the first camp and a second mobile carrier corresponding to the second camp therein.

In step S120, a material is controlled to move in the virtual interactive environment in response to contact interaction (first contact interaction) between the first character or the second character and the material.

In step S130, the first mobile carrier or the second mobile carrier is controlled in response to the material moving into the first mobile carrier or the second mobile carrier, to adjust a position of the first mobile carrier or the second mobile carrier in the virtual interactive environment, and prompt information is displayed on a graphical user interface of a terminal device based on the position of the first mobile carrier or the second mobile carrier in the virtual interactive environment. The prompt information is configured to represent movement information of the first mobile carrier and/or the second mobile carrier.

In step S140, the present game is settled in response to the movement information of the first mobile carrier or the second mobile carrier meeting a preset settlement condition.

The terminal device involved in embodiments of the present disclosure mainly refers to an intelligent device that provides the graphical user interface and can control the virtual objects. The terminal device can include but is not limited to any of the following devices: smartphones, tablets, portable computers, desktop computers, digital TVs, game consoles, etc. The terminal device is equipped with an application that supports the game, for example, the application that supports 3D or 2D games, the application can be installed and run on the terminal device. In embodiments of the present disclosure, the game application is taken as an example of the application for description. In some embodiments, the application can be an online game application or a console game application.

The graphical user interface is a display format of an interface for communication between humans and computers, allowing users to manipulate icons or menu options on the display screen by using input devices such as a mouse, a keyboard, a game controller, etc. It also allows users to manipulate icons or menu options on the display screen by performing touch operations on a touch screen of the terminal device, to select commands, start programs, or perform other tasks.

The mobile carrier is a transporter that can carry virtual objects and move, such as vehicles, planes, and ships in the virtual interactive environment. The mobile carrier may not be able to be directly controlled by players, but can respond to the interactive behaviors (such as placing the virtual object on the mobile carrier, etc.) of virtual characters in the virtual interactive environment, and make corresponding representations. The material is the virtual object in the virtual interactive environment, which is directly controlled by players and can respond to the interactive behaviors (such as lifting, pushing, etc.) of virtual characters in the virtual interactive environment. For example, the virtual character can lift or push the material, etc.

Taking that the above method is applied to the server as an example, each step of the method provided in embodiments of the present disclosure will be explained separately.

In step S110, the server provides, in response to the starting condition of the present game, the virtual interactive environment configured for interaction between the first character belonging to the first camp and the second character belonging to the second camp. The virtual interactive environment has the first mobile carrier corresponding to the first camp and the second mobile carrier corresponding to the second camp therein.

In some embodiments of the present disclosure, the starting condition is issued by the game player to the server by using the terminal device, which is used to control the start of the present game. It can be understood that the game player sends a start request for the present game to the server through the terminal device. After receiving the start request for the present game, the server determines whether the received start request from the game player meets the starting condition for the present game. If the start request meets the starting condition, the server controls the start of the present game. In some embodiments, the starting condition for present game can include the following: the number of virtual characters participating in the present game meets the preset number required, such as 12, 14, and 16 persons; and the online duration of each of virtual characters participating in the present game do not exceed a preset limit duration specified in the game. In order to prevent game players from playing for too long and affecting their vision, the server sets a preset limit duration. If the online duration of the game player exceeds the preset limit duration, the server will force the game player to exit the game.

In some embodiments, the virtual interactive environment includes several first characters (belonging to the first camp) and several second characters (belonging to the second camp), as well as the first mobile carrier and the second mobile carrier. The first mobile carrier has a binding relationship with the first camp, and the second mobile carrier has a binding relationship with the second camp. For example, for the first camp, in order to win the game, the first mobile carrier needs to reach the endpoint before the second mobile carrier, so that the several first characters in the first camp can win the game. On the contrary, if the second mobile carrier reaches the endpoint before the first mobile carrier, the first camp loses the game.

In some embodiments, the movement of the first mobile carrier is used to determine whether the first character in the first camp can win the game, and the movement of the second mobile carrier is used to determine whether the second character in the second camp can win the game. For example, if the first character pushes the material into the second mobile carrier, the quantity of the material in the second mobile carrier increases, causing the second mobile carrier to move towards the endpoint. When the second mobile carrier reaches the endpoint, it means that the second characters in the second camp win the game. That is, even if the first character pushes the material into the second mobile carrier, the final winner will still be the second characters.

In step S120, the server controls the material to move in the virtual interactive environment in response to the contact interaction between the first character or the second character and the material.

In some embodiments of the present disclosure, the contact interaction refers to an interactive behavior generated through controlling of the contact between the virtual character and material by the game player by using the terminal device. The contact herein can be purely physical contact, such as touching contact, rushing contact, fondling contact, etc. The contact interaction can be understood as the interactive behavior where the first character or the second character to approach the material infinitely until they come to stick to each other (such as pushing or lifting), which is controlled by the game player. Through the interactive behavior, the server can control the material to move in the virtual interactive environment. In some embodiments, the contact interaction can also refer to the interaction behavior generated by the contact between virtual objects and materials in the virtual interactive environment. Through the contact interaction between virtual objects and materials, materials can also be controlled to move in the virtual interactive environment.

In some embodiments, there are two kinds of ways in which the material moves in the virtual interactive environment. In the first kind of way, game players control the movement of the material in the virtual interactive environment through virtual characters, and in the second kind of way, the material is set to move in the virtual interactive environment in the game.

For the first kind of way, step S120 includes: determining an interaction parameter of the contact interaction between the first character or the second character and the material, in response to the contact interaction between the first character or the second character and the material; determining a movement parameter of the material based on the interaction parameter; and controlling the material to move in the virtual interactive environment based on the movement parameter.

In some embodiments, the interaction parameter (the first interaction parameter) of the contact interaction between the first character or the second character and the material includes a force exerted by the first character or the second character on the material and a direction of the force. The movement parameter of the material is determined based on the interaction parameter of the contact interaction between the first character or the second character and the material. The movement parameter includes a movement direction, a movement acceleration, and a movement distance of the material.

In some embodiments, a weight of the material is preset in the game. The movement acceleration of the material is determined based on the force exerted by the first character or the second character on the material and the weight of the material. The movement direction of the material is determined based on the direction of the force exerted by the first character or the second character on the material. The movement distance of the material is determined based on the movement acceleration of the material determined and the movement time of the material obtained through the statistics.

In some embodiments, step S120 includes: binding the material with the first character or the second character in response to a picking operation exerted on the material by the first character or the second character; and in response to a directional control operation for the first character or the second character, controlling the first character or the second character to move in the virtual interactive environment, and controlling the material to move with the first character or the second character in the virtual interactive environment.

In some embodiments, the picking operation is used to represent the contact interaction behavior exerted on the material by the first character or the second character, which can include operations such as rushing, lifting, or scooping, etc. The material is bound to the first character or the second character through the picking operation. The bound material is integrated with the first character, or the bound material is integrated with the second character, with the same motion state between them. The directional control operation is used to control the movement direction of the first character or the second character in the virtual interactive environment, thereby controlling the first character or the second character to move in the virtual interactive environment according to the movement direction. Due to the binding of the material with the first character or the second character, when the first character or the second character moves in the virtual interactive environment, the material will follow the first character or the second character to move in the virtual interactive environment.

For the second kind of way, a displacing component is provided in the virtual interactive environment to drive the material to move. In response to contact interaction (second contact interaction) between the displacing component and the material, an interaction parameter (the second interaction parameter) of the contact interaction between the displacing component and the material is determined. The movement parameter of the material is determined based on the interaction parameters. The material is controlled to move in the virtual interactive environment based on the movement parameter.

In some embodiments, the displacing component is used to represent a component that can drive the material to move in the virtual interactive environment. The material can be driven to move in the virtual interactive environment by contacting the material with the displacing component. In some embodiments, the displacing component includes at least one of the following: a conveyor belt control, a steering wheel control, a spring control, a push rod control, a wind blowing control, and a water flowing control.

The interaction parameter is used to represent various parameters generated during the contact interaction between the displacing component and the material, such as a relative position of the material on the displacing component, a relative movement speed of the material relative to the displacing component, an interaction time of the contact interaction between the material and the displacing component, and a relative direction of the material relative to the displacing component. The movement parameter is determined based on the interaction parameter, including a movement direction, a movement speed, and a movement distance of the material.

In some embodiments, the movement parameter of the displacing component is preset on the server. The movement parameter of the displacing component includes the movement direction and the movement speed of the displacing component. The movement speed of the material is determined based on the movement speed of the displacing component and the relative movement speed of the material relative to the displacing component. The movement direction of the material is determined based on the relative direction of the material relative to the displacing component and the movement direction of the displacing component. The relative movement distance of the material relative to the displacing component is determined based on the relative movement speed of the material relative to the displacing component and the contact time of the contact interaction between the material and the displacing component. The movement distance of the material is determined based on the relative position of the material on the displacing component and the relative movement distance of the material relative to the displacing component.

In some embodiments, a displacing component is provided in the virtual interactive environment to drive the material to move. In response to the contact interaction between the displacing component and the material, parameters during the contact interaction between the material and the displacing component, such as the relative position of the material on the displacing component, the relative movement speed of the material relative to the displacing component, the contact time of the contact interaction between the material and the displacing component, and the relative direction of the material relative to the displacing component, are determined. The movement direction, the movement speed, and the movement distance of the material are determined based on the relative position, the relative movement speed, the contact time of the contact interaction, and the relative direction. The material is controlled to move in the virtual interactive environment based on the movement direction, the movement speed, and the movement distance of the material.

In some embodiments, the displacing component includes a conveyor belt control, which is a simulation result of a conveyor belt in a real world in the virtual interactive environment. The conveyor belt control can complete the transportation of the material in the virtual interactive environment. The material is placed on the conveyor belt control to achieve the contact between the conveyor belt control and the material, so that the material moves as the conveyor belt control moves. In some embodiments, the conveyor belt control is arranged along a direction from a starting position towards an ending position of the first mobile carrier or the second mobile carrier in the virtual interactive environment, to drive the material to move from the starting position to the ending position.

In some embodiments, the displacing component includes a steering wheel control, which is a simulation result of a steering wheel in a real world in the virtual interactive environment. The steering wheel control can not only control the movement direction of the material in the virtual interactive environment, but also allow the material to rotate with the steering wheel control. The material is placed on the steering wheel control to achieve the contact between the steering wheel control and the material, so as to make the material rotate as the steering wheel control rotates.

In some embodiments, the displacing component includes a conveyor belt control and a steering wheel control. The steering wheel control and the conveyor belt control are integrated together. The material is placed on the conveyor belt control, and the material moves as the conveyor belt control moves. When moved to the steering wheel control, the material rotates as the steering wheel control rotates, not only changing the movement direction of the material, but also changing the movement path of the material.

In some embodiments, the displacing component includes a spring control, which is a simulation result of a spring in a real world in the virtual interactive environment. The spring control is used to bounce the refreshed material to change the movement path of the material in the virtual interactive environment. At the same time, due to the irregular and uncertain movement path of the material bounced by the spring control, it increases the difficulty of contact interaction between the virtual character and the material, so as to prevent players from losing interest in the game due to simple movement path for action during the game.

In some embodiments, the displacing component includes a push rod control, which is a simulation result of a push rod in a real world in the virtual interactive environment. The push rod generally allows a mother ball to move forward and achieve natural forward rolling through friction with the baize. Generally, after hitting a target ball, the mother ball will move forward a short distance due to its own forward rolling. In the virtual interactive environment, the push rod control is used to make a target material obtain a natural forward rolling force at the initial moment when moving forward. After hitting other materials, the target material will move forward for a short distance by means of its own forward rolling force, so that the material in the virtual interactive environment can move in the same way as above.

In some embodiments, the displacing component includes a wind blowing control, which is a control that simulates wind blowing in the virtual interactive environment. The wind blowing control is arranged at the location where the material is generated, and with the help of the contact between the wind force and the material, the material is blown away to various positions in the virtual interactive environment to achieve the movement of the material.

In some embodiments, the displacing component includes a water flowing control, which is a control that simulates water flowing in the virtual interactive environment. The water flowing control is arranged at the location where the material is generated, and with the help of the contact between the water flow and the material, the material is washed away to various positions in the virtual interactive environment to achieve the movement of the material.

Embodiments of the present disclosure can achieve the movement of the material in the virtual interactive environment without human contact by providing physical displacing components as described above.

In step S130, the first mobile carrier or the second mobile carrier is controlled in response to the material moving into the first mobile carrier or the second mobile carrier, to adjust the position of the first mobile carrier or the second mobile carrier in the virtual interactive environment, and the prompt information configured to represent the movement information of the first mobile carrier and/or the second mobile carrier is displayed on the graphical user interface of the terminal device based on the position of the first mobile carrier or the second mobile carrier in the virtual interactive environment.

In some embodiments of the present disclosure, taking that the server responds to the material moving into the first mobile carrier as an example, the server controls the first mobile carrier to adjust the position of the first mobile carrier in the virtual interactive environment in response to the material moving into the first mobile carrier, and displays the prompt information configured to represent the movement information of the first mobile carrier on the graphical user interface of the terminal device based on the position of the first mobile carrier in the virtual interactive environment.

In some embodiments of the present disclosure, the movement information includes the current position and the relative distance of the first mobile carrier in the virtual interactive environment. In some embodiments, the current position is the position of the first mobile carrier in the virtual interactive environment after the position has been adjusted, and the relative distance is the distance between the current position of the first mobile carrier in the virtual interactive environment and the initial position of the first mobile carrier in the virtual interactive environment.

In some embodiments of the present disclosure, the prompt information is used to prompt game players about the current position and relative distance of the first mobile carrier in the virtual interactive environment, so that the game players can quickly obtain the current position of the first mobile carrier, facilitate quickly locating of the first mobile carrier by the players, thereby improving the accuracy of pushing the material towards the first mobile carrier by the players. At the same time, according to the prompt information, the progress of the game can also be quickly obtained.

In some embodiments, when displaying the prompt information on the graphical user interface of the terminal device, it is possible to display only the prompt information of one's own camp. That is, the prompt information configured to represent the movement information of the first mobile carrier or the second mobile carrier can be displayed. It is also possible to display the prompt information of both camps. That is, the prompt information configured to represent the movement information of the first mobile carrier and the second mobile carries can be displayed. Embodiments of the present disclosure is preferably to display the prompt information of both camps. For players themselves, the prompt information of their own camp can help they quickly locate the position of the mobile carrier, and through the prompt information of both camps, the players can timely know the opponent's situation and adjust their tactical layout.

In some embodiments, a step of controlling the first mobile carrier to adjust the position of the first mobile carrier in the virtual interactive environment includes: determining the movement distance of the first mobile carrier based on the quantity of materials moving into the first mobile carrier when the material moves into the first mobile carrier; controlling, based on the determined movement distance, the first mobile carrier to move in the virtual interactive environment.

In some embodiments of the present disclosure, the quantity of materials moving into the first mobile carrier determines the movement distance of the first mobile carrier. The more materials moving into the first mobile carrier are, the greater the movement distance of the first mobile carrier in the virtual interactive environment is.

In some embodiments, the first mobile carrier is generally driven to move when the material moves into the first mobile carrier.

In some embodiments of the present disclosure, when playing the game, one material is pushed into the first mobile carrier, the first mobile carrier is generally driven forward by a preset distance. In some embodiments, the preset distance can be determined based on the quantity of materials that the first mobile carrier can accommodate and the distance between the starting position of the first mobile carrier in the virtual interactive environment and the victory endpoint.

In some embodiments, a step of controlling the second mobile carrier to adjust the position of the second mobile carrier in the virtual interactive environment includes: determining the movement distance of the second mobile carrier based on the quantity of materials moving into when the material moves into the second mobile carrier; controlling, based on the determined movement distance, the second mobile carrier to move in the virtual interactive environment. The principle of controlling the second mobile carrier to adjust its position in the virtual interactive environment is the same as the principle of controlling the first mobile carrier to adjust its position in the virtual interactive environment, and will not be repeated herein.

In some embodiments, the movement includes one of the following: unidirectional movement, reciprocating movement, folded-line movement, and curve-line movement.

In some embodiments, when the movement is the unidirectional movement, when the material moves into the first mobile carrier, the movement distance of the first mobile carrier is determined based on the quantity of materials moving into the first mobile carrier. The first mobile carrier is controlled to move in a unidirectional direction in the virtual interactive environment based on the determined movement distance. The movement direction of the unidirectional movement is parallel to the movement direction of the material in the virtual interactive environment controlled by the server. In some embodiments, as the quantity of materials in the first mobile carrier increases, the first mobile carrier moves in a unidirectional direction all the time. When the first mobile carrier reaches the specified endpoint of the game, the first character wins the game.

In some embodiments, when the movement is reciprocating, the condition for determining who wins the game can be the quantity of materials in the mobile carrier. When the material moves into the first mobile carrier, the reciprocating distance of the first mobile carrier is determined based on the quantity of materials moving into the first mobile carrier. For example, if the condition for winning the game is that the quantity of materials in the mobile carrier reaches 100, it can be set that when the quantity of materials in the mobile carrier is between 1 and 30, the mobile carrier moves in the first direction, and when the quantity of materials in the mobile carrier is between 31 and 60, the mobile carrier moves in the second direction. When the quantity of materials in the mobile carrier is between 61 and 90, the mobile carrier moves in the first direction, and when the quantity of materials in the mobile carrier is between 91 and 100, the mobile carrier moves in the second direction. The first direction is opposite to the second direction. When the quantity of materials in the mobile carrier reaches 100, the mobile carrier does not move. At the same time, the players in the camp whose materials in the mobile carrier first reach 100 win.

In some embodiments, the way of controlling the first mobile carrier to move in a folded-line or curved-line in the virtual interactive environment can make reference to the reciprocating movement.

In some embodiments of the present disclosure, a step of displaying the prompt information configured to represent the movement information of the first mobile carrier on the graphical user interface of the terminal device includes: determining real-time variable progress information of the first mobile carrier based on real-time variable information of the first mobile carrier and preset total variable information; or determining real-time variable progress information of the second mobile carrier based on real-time variable information of the second mobile carrier and the preset total variable information; or, determining the real-time variable progress information of the first mobile carrier and the second mobile carrier based on the real-time variable information of the first mobile carrier and the second mobile carrier and the preset total variable information. The preset total variable information is used as a condition for winning the game in the present game. The real-time variable progress information is displayed on the graphical user interface of the terminal device.

In some embodiments, real-time variable information is configured to represent the variable parameter that the first mobile carrier or the second mobile carrier changes in real time based on the quantity of materials, which can include the movement distance of the first mobile carrier or the second mobile carrier in the virtual interactive environment, as well as the quantity of materials in the first mobile carrier or the second mobile carrier. In some embodiments, when the real-time variable information is the movement distance of the first mobile carrier or the second mobile carrier in the virtual interactive environment, the preset total variable information is the total movement distance of the mobile carrier preset by the system when the mobile carrier wins the game. In some embodiments, the real-time variable progress information can be the proportional relationship between the movement distance of the first mobile carrier or the second mobile carrier in the virtual interactive environment and the total movement distance of the mobile carrier preset by the system when the mobile carrier wins the present game. When the real-time variable information is the quantity of materials in the first mobile carrier or the second mobile carrier, the preset total variable information is the total quantity of materials accommodated in the mobile carrier preset by the system when the mobile carrier wins the present game. In some embodiments, the real-time variable progress information can be the proportional relationship between the quantity of materials in the first mobile carrier or the second mobile carrier and the total quantity of materials accommodated in the mobile carrier preset by the system when the mobile carrier wins the present game.

In some embodiments of the present disclosure, the relative position relationship between the first mobile carrier and/or the second mobile carrier and a target character is determined based on a current position of the first mobile carrier and/or the second mobile carrier, as well as a position of the target character out of the first character and/or the second character in the virtual interactive environment. The relative position relationship between the first mobile carrier and/or the second mobile carrier and the target character is displayed using a direction indication sign, with the direction indicated by the direction indication sign being from the target character pointing towards the first mobile carrier and/or the second mobile carrier.

In some embodiments, in the first case, the relative position relationship between the first mobile carrier or the second mobile carrier and the target character is determined based on the current position of the first mobile carrier or the second mobile carrier, as well as the position of the target character out of the first character or the second character in the virtual interactive environment. The relative position relationship between the first mobile carrier or the second mobile carrier and the target character is displayed using the direction indication sign, with the direction indicated by the direction indication sign being from the target character pointing towards the first mobile carrier or the second mobile carrier. In the second case, the relative position relationship between the first mobile carrier and the second mobile carrier and the target character in the virtual interactive environment is determined based on their current positions, as well as the positions of the target characters out of the first character and the second character. The relative position relationship between the first mobile carrier or the second mobile carrier and the target character is displayed using the direction indication sign, with the direction indicated by the direction indication sign being from the target character pointing towards the first mobile carrier and the second mobile carrier.

In some embodiments of the present disclosure, the direction indicated by the direction indication sign is from the target character towards the first mobile carrier and/or the second mobile carrier. In some embodiments, the direction indication sign can adopt an arrow. In this way, even if the position of the first mobile carrier or the second mobile carrier changes in the virtual interactive environment, the target character can quickly locate the position of the first mobile carrier or the second mobile carrier at any time according to the direction indication sign, so that the target character can accurately push the material into the mobile carrier.

In some embodiments, the target character can only be a virtual character controlled by the game player himself, can be all virtual characters within the camp where the virtual character controlled by the game player is located, or can be all virtual characters in both camps.

In some embodiments, the way of displaying the real-time variable progress information includes one of the following forms: the progress bar, the percentage, and the figure representing the quantity of materials on the first mobile carrier and the second mobile carrier.

When the real-time variable progress information is displayed in the form of the progress bar, for example, the progress bars corresponding to the first camp and the second camp are displayed on the graphical user interface. A total length of the progress bar represents the preset total variable information, a movement indicator on the progress bar is used to represent real-time variable information, and a position of the movement indicator on the progress bar is used to represent the real-time variable progress information.

When the real-time variable progress information is displayed in the form of the percentage, for example, the form of the percentage can be a disk, where the entire disk is used to represent the preset total variable information, and the pink area on the disk is used to represent the real-time variable information. The proportion of the pink area on the disk to the entire disk is used to represent the real-time variable progress information.

When the real-time variable progress information is displayed in the form of the figure representing the quantity of materials on the first mobile carrier and the second mobile carrier, the condition for winning the game can only be that the quantity of materials in the mobile carrier reaches the preset total quantity of materials accommodated in the mobile carrier when the mobile carrier wins the game.

In some embodiments of the present disclosure, the method further includes: the material is refreshed at a preset material refresh position in response to a material refresh condition of the present game.

In some embodiments, the material refresh condition can be that a time process meets a preset interval threshold condition, or can be a condition where a quantity of a material that exists in the virtual interactive environment of the present game and does not move into the first mobile carrier or the second mobile carrier is less than a preset quantity threshold. The material refresh position at least includes one of the following: a fixed material refresh position in the virtual interactive environment; multiple material refresh positions arranged sequentially along a preset direction; a material refresh position adjusted in real-time based on the position of the first mobile carrier and/or the second mobile carrier; and a material refresh position adjusted according to a time progress of the present game.

In some embodiments, the time process can be either the time during which the game has been conducted or the time that is started timing after the material disappears, which, for the preset interval threshold condition and the preset quantity threshold condition, are both fixed values set based on the game content.

The fixed material refresh position in the virtual interactive environment refers to the fact that there is only one material refresh position in the virtual interactive environment, and the material refresh position is fixed and unchanged. The multiple material refresh positions arranged sequentially along the preset direction refer to multiple material refresh positions arranged along a direction parallel to the movement direction of the mobile carrier, with equal spacing between adjacent material refresh positions. The material refresh position adjusted in real-time based on the position of the first mobile carrier and/or the second mobile carrier refers to the real-time change of the material refresh position with the position of the first mobile carrier and/or the second mobile carrier. For example, a midpoint position of a line connecting the first mobile carrier and the second mobile carrier can be used as the material refresh position, or the material refresh position can be adjusted to the closest position to the first mobile carrier and the second mobile carrier. The material refresh position adjusted according to the time progress of the present game refers to adjusting a previous material refresh position by a preset distance to obtain a next material refresh position, with the preset distance being determined based on the game's progress time.

In some embodiments, after the present game starts, in response to a time process of the present game meeting the preset interval threshold condition, the material is refreshed at the preset material refresh position. Alternatively, in response to the condition where the quantity of materials that exist in the virtual interactive environment of the present game and have not moved into the first mobile carrier or the second mobile carrier is less than the preset quantity threshold, the material is refreshed at the preset material refresh position.

For example, it can be set a refresh every two minutes after the game starts, or start timing if one material disappears, and refresh once in 1 minute, or refresh when the remaining quantity of materials in the virtual interactive environment is insufficient.

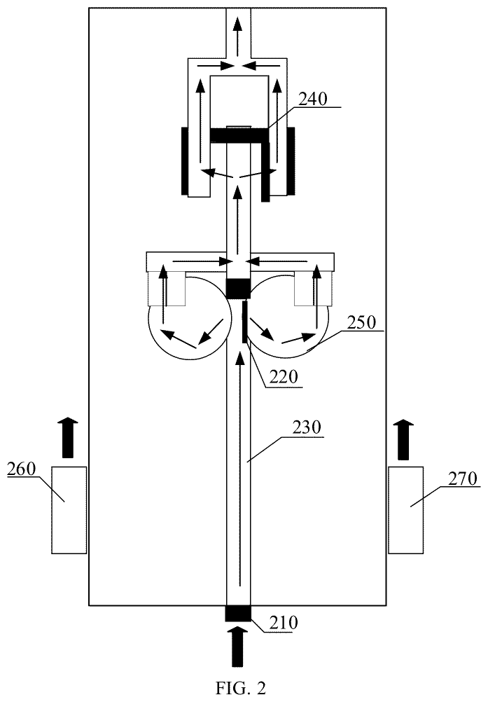

In some embodiments, reference is made to FIG. 2, which is a design diagram of a level in a multiplayer online competitive game according to embodiments of the present disclosure. The design of the level in the multiplayer online competitive game can apply the method for processing the information in the game. As shown in FIG. 2, the first character in the first camp and the second character in the second camp compete in the present game, and the player in the game camp who completes the setting tasks in the game first wins the game. At the beginning of the present game, players in the match are divided into two different game camps, and the tasks set for players in the same game camp are the same. For example, the main task of the game is to use the collision of the eggy itself to push fuel onto the trolley of its own team, accelerating the trolley's movement speed and approaching the endpoint faster. When the team's trolley reaches the endpoint, the players in the self team win the game, and when the trolley of an opposite team reaches the endpoint, the players in the self team lose the game. In some embodiments, in the virtual interactive environment of the present game, it includes fuel generator 210, ball splitter 220, conveyor belt 230, blocking board 240, turntable 250, trolley 260 of team 1, and trolley 270 of team 2. The fuel generator 210 generates spherical fuel, which automatically travels with conveyor belt 230. The arrows in the drawing are used to indicate a travelling path of the spherical fuel along the conveyor belt 230. Physical means such as blocking plate 240 are used to move the spherical fuel on the ball splitter 220 and the turntable 250. The game players from different game camps control their characters in the virtual interactive environment to compete for the fuel on the conveyor belt 230, and push the fuel onto the trolley of their own team's (such as the trolley 260 of team 1 or the trolley 270 of team 2). The two team's trolleys compete to each other for reaching the endpoint first, and the team that reaches the endpoint first wins the game.

Embodiments of the present disclosure provide a method for processing information in a game. According to the method for processing the information in the game, the material can be controlled to move in the virtual interactive environment in response to the contact interaction between the first character or the second character and the material in the virtual interactive environment, and the position of the first mobile carrier or the second mobile carrier in the virtual interactive environment is adjusted after the material moves into the first mobile carrier or the second mobile carrier. At the same time, the prompt information is displayed on the graphical user interface of the terminal device based on the position of the first mobile carrier or the second mobile carrier in the virtual interactive environment, the prompt information is configured to represent the movement information of the first mobile carrier and/or the second mobile carrier, and the present game is settled based on the relationship between the movement information and the preset settlement condition. The position of the first mobile carrier or the second mobile carrier in the virtual interactive environment can be determined based on the condition where the material moves into the first mobile carrier or the second mobile carrier, that is, the position of the first mobile carrier or the second mobile carrier in the virtual interactive environment changes in real time, and the real-time changing position can be displayed on the graphical user interface. Finally, whether the players win the game is determined based on the final position of the first mobile carrier or the second mobile carrier in the virtual interactive environment. In this way, based on embodiments of the present disclosure, the position of the mobile carrier in the virtual interactive environment can be displayed on the graphical user interface in real-time, to prompt the game players the progress of the game and help them quickly locate the position of the mobile carrier in the virtual interactive environment, thereby improving the locating accuracy of the game.

Based on the same inventive concept, embodiments of the present disclosure also provide an apparatus for processing information in a game corresponding to the method for processing the information in the game. Since the principle of solving the problem by the apparatus in embodiments is similar to the method for processing the information in the game mentioned in method embodiments, implementations of the apparatus can make reference to the implementations of the methods, which will not be repeated herein.

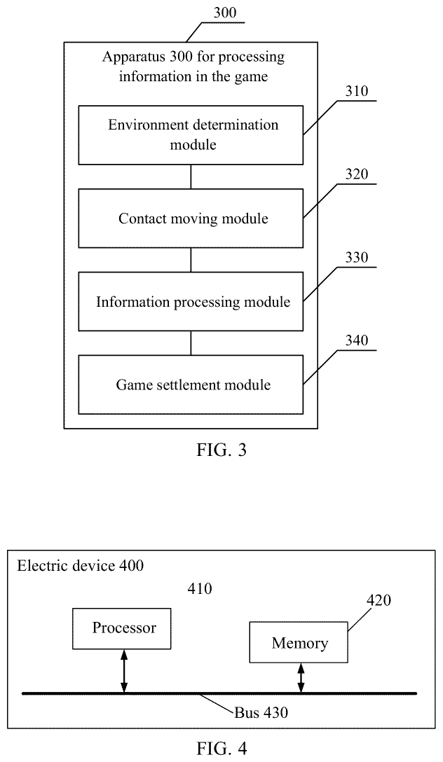

Referring to FIG. 3, which is a schematic structural diagram of an apparatus for processing information in a game according to some embodiments of the present disclosure. As shown in FIG. 3, the apparatus 300 for processing the information in the game provided by embodiments includes an environment determination module 310, a contact moving module 320, an information processing module 330, and a game settlement module 340.

The environment determination module 310 is configured to provide, in response to a starting condition of a present game, a virtual interactive environment configured for interaction between a first character belonging to a first camp and a second character belonging to a second camp, and the virtual interactive environment having a first mobile carrier corresponding to the first camp and a second mobile carrier corresponding to the second camp.

The contact moving module 320 is configured to control, in response to contact interaction between the first character or the second character and the material, the material to move in the virtual interactive environment.

The information processing module 330 is configured to control, in response to the material moving into the first mobile carrier or the second mobile carrier, the first mobile carrier or the second mobile carrier to adjust a position of the first mobile carrier or the second mobile carrier in the virtual interactive environment, and display, based on the position of the first mobile carrier or the second mobile carrier in the virtual interactive environment, prompt information on a graphical user interface of a terminal device, the prompt information being configured to represent movement information of the first mobile carrier and/or the second mobile carrier.

The game settlement module 340 is configured to settle, in response to the movement information of the first mobile carrier or the second mobile carrier meeting a preset settlement condition, the present game.

In some embodiments of the present disclosure, the information processing device 300 further includes a material refresh module (not shown in the drawing), and the material refresh module is configured to refresh, in response to a material refresh condition of the present game, the material at a preset material refresh position.

In some embodiments of the present disclosure, the material refresh module is configured to after the present game starts, refresh, in response to a time process of the present game meeting a preset interval threshold condition, the material at the preset material refresh position.

In some embodiments of the present disclosure, the material refresh module is configured to refresh, in response to a condition where a quantity of a material that exists in the virtual interactive environment of the present game and does not move into the first mobile carrier or the second mobile carrier being less than a preset quantity threshold, the material at the preset material refresh position.

In some embodiments of the present disclosure, the material refresh position includes at least one of the following:
a fixed material refresh position in the virtual interactive environment;
multiple material refresh positions arranged sequentially along a preset direction;
a material refresh position adjusted in real-time based on the position of the first mobile carrier and/or the second mobile carrier; and
a material refresh position adjusted according to a time progress of the present game.

In some embodiments of the present disclosure, the contact moving module 320 is configured to determine, in response to the contact interaction between the first character or the second character and the material, an interaction parameter of the contact interaction between the first character or the second character and the material; determine a movement parameter of the material based on the interaction parameter; and control the material to move in the virtual interactive environment based on the movement parameter of the material.

In some embodiments of the present disclosure, the contact moving module 320 is configured to bind, in response to a picking operation exerted on the material by the first character or the second character, the material with the first character or the second character; control, in response to a directional control operation for the first character or the second character, the first character or the second character to move in the virtual interactive environment, and control the material to move with the first character or the second character in the virtual interactive environment.

In some embodiments of the present disclosure, a displacing component for driving material to move is provided in the virtual interactive environment, and the apparatus 300 for processing the information further includes a displacement module (not shown in the drawing), which is configured to determine, in response to contact interaction between the displacing component and the material, an interaction parameter of the contact interaction between the displacing component and the material; determine a movement parameter of the material based on the interaction parameter; and control the material to move in the virtual interactive environment based on the movement parameter of the material.

In some embodiments of the present disclosure, the displacing component is arranged along a direction from a starting position towards an ending position of the first mobile carrier or the second mobile carrier in the virtual interactive environment, to drive the material to move from the starting position to the ending position.

In some embodiments of the present disclosure, the displacing component includes at least one of the following: a conveyor belt control, a steering wheel control, a spring control, a push rod control, a wind blowing control, and a water flowing control.

In some embodiments of the present disclosure, the information processing module 330 is configured to determine, when the material moves into the first mobile carrier or the second mobile carrier, a movement distance of the first mobile carrier or the second mobile carrier based on a quantity of a material moving into the first mobile carrier or the second mobile carrier; and control the first mobile carrier or the second mobile carrier to move in the virtual interactive environment based on the movement distance determined.

In some embodiments of the present disclosure, the movement includes one of unidirectional movement, reciprocating movement, folded-line movement, and curve-line movement.

In some embodiments of the present disclosure, the information processing module 330 is configured to determine real-time variable progress information of the first mobile carrier and/or the second mobile carrier based on real-time variable information of the first mobile carrier and/or the second mobile carrier and preset total variable information, the preset total variable information being configured as a condition for winning the present game; and display the real-time variable progress information on the graphical user interface of the terminal device.

In some embodiments of the present disclosure, a way of display the real-time variable progress information includes one of following forms: a progress bar, a percentage, and a figure representing a quantity of a material on the first mobile carrier and the second mobile carrier.

In some embodiments of the present disclosure, the information processing module 330 is configured to determine a relative position relationship between the first mobile carrier and/or the second mobile carrier and a target character based on a current position of the first mobile carrier and/or a current position of the second mobile carrier, as well as a position of the target character out of the first character and/or the second character in the virtual interactive environment; and displaying the relative position relationship between the first mobile carrier and/or the second mobile carrier and the target character using a direction indication sign, a direction indicated by the direction indication sign being from the target character pointing towards the first mobile carrier and/or the second mobile carrier.

Embodiments of the present disclosure provide an apparatus for processing information in a game. The apparatus for processing the information in the game includes an environment determination module, a contact moving module, an information processing module, and a game settlement module. The environment determination module is configured to provide, in response to a starting condition of a present game, a virtual interactive environment configured for interaction between a first character belonging to a first camp and a second character belonging to a second camp, and the virtual interactive environment having a first mobile carrier corresponding to the first camp and a second mobile carrier corresponding to the second camp. The contact moving module is configured to control, in response to contact interaction between the first character or the second character and the material, the material to move in the virtual interactive environment. The information processing module is configured to control, in response to the material moving into the first mobile carrier or the second mobile carrier, the first mobile carrier or the second mobile carrier to adjust a position of the first mobile carrier or the second mobile carrier in the virtual interactive environment, and display, based on the position of the first mobile carrier or the second mobile carrier in the virtual interactive environment, prompt information on a graphical user interface of a terminal device, the prompt information being configured to represent movement information of the first mobile carrier and/or the second mobile carrier. The game settlement module is configured to settle, in response to the movement information of the first mobile carrier or the second mobile carrier meeting a preset settlement condition, the present game.

In this way, according to embodiments of the present disclosure, the position of the first mobile carrier or the second mobile carrier in the virtual interactive environment can be determined based on the condition where the material moves into the first mobile carrier or the second mobile carrier, that is, the position of the first mobile carrier or the second mobile carrier in the virtual interactive environment changes in real time, and the real-time changing position can be displayed on the graphical user interface. Finally, whether the players win the game is determined based on the final position of the first mobile carrier or the second mobile carrier in the virtual interactive environment. Based on embodiments of the present disclosure, the position of the mobile carrier in the virtual interactive environment can be displayed on the graphical user interface in real-time, to prompt the game players the progress of the game and help them quickly locate the position of the mobile carrier in the virtual interactive environment, thereby improving the locating accuracy of the game.

Referring to FIG. 4, which is a schematic structural diagram of an electronic device according to some embodiments of the present disclosure. As shown in FIG. 4, the electronic device 400 includes a processor 410, a memory 420, and a bus 430.

The memory 420 stores machine readable instructions executable by the processor 410. When the electronic device 400 is running, the processor 410 communicates with the memory 420 through the bus 430. When the machine readable instructions are executed by the processor 410, the steps of the method for processing the information in the game in method embodiments can be executed. Specific implementations can be obtained in above method embodiments, which will not be repeated herein.

Embodiments of the present disclosure also provide a computer-readable storage medium, on which a computer program is stored. When the computer program is executed by a processor, the steps of the method for processing the information in the game can be executed. Specific implementations can be obtained in above method embodiments, which will not be repeated herein.

Those skilled in the art can clearly understand that, for the convenience and simplicity of description, the specific working process of the above described systems and devices can refer to the corresponding process in the above method embodiments, which will not be repeated herein.

In addition, in the description of the embodiments of the present disclosure, unless otherwise specified and defined, the terms “installation”, “connection” and “connection” should be understood broadly, for example, they can be fixed connection, removable connection, or integrated connection; It can be mechanical connection or electrical connection; It can be directly connected, or indirectly connected through intermediate media. It can be the connection between two components. For those skilled in the art, the specific meaning of the above terms in this disclosure can be understood in specific cases.

If the functions are realized in the form of software functional units and sold or used as independent products, they can be stored in a computer readable storage medium. Based on this understanding, the technical solution of the present disclosure can be embodied in the form of a software product, which is stored in a storage medium, A number of instructions are included to enable a computer device (which may be a personal computer, a server, or a network device, etc.) to perform all or part of the steps of the method described in various embodiments of the present disclosure. The aforementioned storage media include: USB flash disk, mobile hard disk, read only memory (ROM), random access memory (RAM), magnetic disc or optical disc and other media that can store program codes.

In the description of the present disclosure, it should be noted that the terms “center”, “top”, “bottom”, “left”, “right”, “vertical”, “horizontal”, “inside”, “outside”, etc. indicate the orientation or position relationship based on the orientation or position relationship shown in the drawings, only for the convenience of describing the present disclosure and simplifying the description, rather than indicating or implying that the device or element referred to must have a specific orientation It is constructed and operated in a specific orientation, and therefore cannot be understood as a limitation of the present disclosure. In addition, the terms “first”, “second” and “third” are only used for describing purposes and cannot be understood as indicating or implying relative importance.

Finally, it should be noted that the above embodiments are only specific embodiments of the disclosure to illustrate the technical solutions of the disclosure, rather than limit them. The scope of protection of the disclosure is not limited to this. Although the disclosure has been described in detail with reference to the aforementioned embodiments, those skilled in the art should understand that: any person skilled in the technical field is within the scope of the disclosure, It can still modify or easily think of changes to the technical solutions recorded in the aforementioned embodiments, or equivalently replace some of the technical features; However, these modifications, changes or substitutions do not make the nature of the corresponding technical solutions deviate from the spirit and scope of the technical solutions of the embodiments of the present disclosure, and should be covered in the scope of protection of the present disclosure. Therefore, the protection scope of the present disclosure shall be subject to the protection scope of the claims.

1. A method for processing information in a game, comprising:
providing, in response to a starting condition of a present game, a virtual interactive environment configured for interaction between a first character belonging to a first camp and a second character belonging to a second camp, wherein the virtual interactive environment comprises a first mobile carrier corresponding to the first camp and a second mobile carrier corresponding to the second camp;
controlling, in response to a first contact interaction between the first character or the second character and a material, the material to move in the virtual interactive environment;
controlling, in response to the material moving into the first mobile carrier or the second mobile carrier, the first mobile carrier or the second mobile carrier to adjust a position of the first mobile carrier or the second mobile carrier in the virtual interactive environment, and displaying, based on the position of the first mobile carrier or the second mobile carrier in the virtual interactive environment, prompt information on a graphical user interface of a terminal device, wherein the prompt information is configured to represent movement information of the first mobile carrier or the second mobile carrier; and
settling, in response to the movement information of the first mobile carrier or the second mobile carrier meeting a preset settlement condition, the present game.

2. The method according to claim 1, further comprising:
refreshing, in response to a material refresh condition of the present game, the material at a preset material refresh position.

3. The method according to claim 2, wherein refreshing, in response to the material refresh condition of the present game, the material at the preset material refresh position comprises:
refreshing, in response to a time process of the present game meeting a preset interval threshold condition, the material at the preset material refresh position.

4. The method according to claim 2, wherein refreshing, in response to the material refresh condition of the present game, the material at the preset material refresh position comprises:
refreshing, in response to determining that a quantity of a material that exists in the virtual interactive environment of the present game and does not move into the first mobile carrier or the second mobile carrier being less than a preset quantity threshold, the material at the preset material refresh position.

5. The method according to claim 2, wherein the material refresh position comprises at least one of:
a fixed material refresh position in the virtual interactive environment;
multiple material refresh positions arranged sequentially along a preset direction;
a material refresh position adjusted in real-time based on the position of the first mobile carrier or the second mobile carrier; or
a material refresh position adjusted according to a time progress of the present game.

6. The method according to claim 1, wherein controlling, in response to the first contact interaction between the first character or the second character and the material, the material to move in the virtual interactive environment comprises:
determining, in response to the first contact interaction between the first character or the second character and the material, a first interaction parameter of the first contact interaction between the first character or the second character and the material;
determining a movement parameter of the material based on the first interaction parameter; and
controlling the material to move in the virtual interactive environment based on the movement parameter of the material.

7. The method according to claim 1, wherein controlling, in response to the first contact interaction between the first character or the second character and the material, the material to move in the virtual interactive environment comprises:
binding, in response to a picking operation exerted on the material by the first character or the second character, the material with the first character or the second character; and
controlling, in response to a directional control operation for the first character or the second character, the first character or the second character to move in the virtual interactive environment, and controlling the material to move with the first character or the second character in the virtual interactive environment.

8. The method according to claim 1, wherein a displacing component for driving the material to move is provided in the virtual interactive environment, and the method further comprises:
determining, in response to a second contact interaction between the displacing component and the material, a second interaction parameter of the second contact interaction between the displacing component and the material;
determining a movement parameter of the material based on the second interaction parameter; and
controlling the material to move in the virtual interactive environment based on the movement parameter of the material.

9. The method according to claim 8, wherein the displacing component is arranged along a direction from a starting position towards an ending position of the first mobile carrier or the second mobile carrier in the virtual interactive environment, to drive the material to move from the starting position to the ending position.

10. The method according to claim 8, wherein the displacing component comprises at least one of a conveyor belt control, a steering wheel control, a spring control, a push rod control, a wind blowing control, or a water flowing control.

11. The method according to claim 1, wherein controlling the first mobile carrier or the second mobile carrier to adjust the position of the first mobile carrier or the second mobile carrier in the virtual interactive environment comprises:
determining, when the material moves into the first mobile carrier or the second mobile carrier, a movement distance of the first mobile carrier or the second mobile carrier based on a quantity of a material moving into the first mobile carrier or the second mobile carrier; and
controlling the first mobile carrier or the second mobile carrier to move in the virtual interactive environment based on the movement distance determined.

12. The method according to claim 11, wherein movement of the first mobile carrier or the second mobile carrier comprises one of unidirectional movement, reciprocating movement, folded-line movement, or curve-line movement.

13. The method according to claim 1, wherein displaying the prompt information on the graphical user interface of the terminal device comprises:
determining real-time variable progress information of the first mobile carrier or the second mobile carrier based on real-time variable information of the first mobile carrier or the second mobile carrier and preset total variable information, wherein the preset total variable information is configured as a condition for winning the present game; and
displaying the real-time variable progress information on the graphical user interface of the terminal device.

14. The method according to claim 13, wherein a way of display the real-time variable progress information comprises one of following forms: a progress bar, a percentage, and a figure representing a quantity of a material on the first mobile carrier or the second mobile carrier.

15. The method according to claim 1, wherein displaying the prompt information on the graphical user interface of the terminal device comprises:
determining a relative position relationship between the first mobile carrier or the second mobile carrier and a target character out of the first character or the second character based on a current position of the first mobile carrier or a current position of the second mobile carrier, as well as a position of the target character in the virtual interactive environment; and
displaying the relative position relationship between the first mobile carrier or the second mobile carrier and the target character using a direction indication sign, wherein a direction indicated by the direction indication sign is from the target character pointing towards the first mobile carrier or the second mobile carrier.

16. (canceled)

17. An electronic device comprising a processor, a memory, and a bus, wherein the memory stores machine readable instructions executable by the processor, and when the electronic device is running, the processor communicates with the memory through the bus, and the processor is configured to:
provide, in response to a starting condition of a present game, a virtual interactive environment configured for interaction between a first character belonging to a first camp and a second character belonging to a second camp, wherein the virtual interactive environment comprises a first mobile carrier corresponding to the first camp and a second mobile carrier corresponding to the second camp;
control, in response to a first contact interaction between the first character or the second character and the material, the material to move in the virtual interactive environment;
control, in response to the material moving into the first mobile carrier or the second mobile carrier, the first mobile carrier or the second mobile carrier to adjust a position of the first mobile carrier or the second mobile carrier in the virtual interactive environment, and display, based on the position of the first mobile carrier or the second mobile carrier in the virtual interactive environment, prompt information on a graphical user interface of a terminal device, wherein the prompt information is configured to represent movement information of the first mobile carrier or the second mobile carrier; and
settle, in response to the movement information of the first mobile carrier or the second mobile carrier meeting a preset settlement condition, the present game.

18. A non-transitory computer-readable storage medium having a program stored thereon, which when executed by a processor, causes a method for processing information in a game to be implemented, wherein the method for processing the information in the game comprises:
providing, in response to a starting condition of a present game, a virtual interactive environment configured for interaction between a first character belonging to a first camp and a second character belonging to a second camp, wherein the virtual interactive environment comprises a first mobile carrier corresponding to the first camp and a second mobile carrier corresponding to the second camp;
controlling, in response to a first contact interaction between the first character or the second character and a material, the material to move in the virtual interactive environment;
controlling, in response to the material moving into the first mobile carrier or the second mobile carrier, the first mobile carrier or the second mobile carrier to adjust a position of the first mobile carrier or the second mobile carrier in the virtual interactive environment, and displaying, based on the position of the first mobile carrier or the second mobile carrier in the virtual interactive environment, prompt information on a graphical user interface of a terminal device, wherein the prompt information is configured to represent movement information of the first mobile carrier or the second mobile carrier; and
settling, in response to the movement information of the first mobile carrier or the second mobile carrier meeting a preset settlement condition, the present game.

19. The method according to claim 6, wherein determining the movement parameter of the material based on the first interaction parameter comprises:
determining a movement acceleration of the material based on a force exerted by the first character or the second character on the material and a weight of the material;
determining a movement direction of the material based on a direction of the force exerted by the first character or the second character on the material; and
determining a movement distance of the material based on the movement acceleration of the material determined and a movement time of the material obtained through statistics.

20. The method according to claim 11, wherein determining the movement distance of the first mobile carrier or the second mobile carrier based on the quantity of the material moving into the first mobile carrier or the second mobile carrier comprises:
driving, in response to one material being pushed into the first mobile carrier or the second mobile carrier, the first mobile carrier or the second mobile carrier to move forward by a preset distance.

21. The method according to claim 20, wherein the preset distance is determined based on the quantity of the material that the first mobile carrier or the second mobile carrier can accommodate and a distance between a starting position of the first mobile carrier or the second mobile carrier in the virtual interactive environment and a victory endpoint.
